(19) United States
(12) Patent Application Publication
(10) Pub. No.: US 2011/0258052 A1
(43) Pub. Date: Oct. 20, 2011

(54) DYNAMIC MECHANISM FOR SELLING ONLINE ADVERTISING SPACE

(75) Inventors: Sham M. Kakade, Philadelphia, PA (US); Ilan Lobel, Cambridge, MA (US); Hamid Nazer Zadeh, Cambridge, MA (US)

(73) Assignee: Microsoft Corporation, Redmond, WA (US)

(21) Appl. No.: 12/761,549

(22) Filed: Apr. 16, 2010

(51) Int. Cl. G06Q 30/00

(52) U.S. Cl. 705/14.69; 705/37; 705/14.4

(57) ABSTRACT

A dynamic mechanism for selling online advertising space may involve computing allocation rules and pricing structures to align incentives of seller and bidders. Based on initial valuations reported by multiple advertisers, an advertising platform may compute entrance fees to be charged to each advertiser who enters into a contract for allocation of an advertising space over multiple allocation cycles. Based on an initial valuation reported by an advertiser, an advertising platform may compute an entrance fee to be charged to the advertiser as a lump sum or subscription fee, determine whether to allocate the advertising space to the advertiser in multiple successive allocation cycles, and compute allocation payment amounts to be charged to the advertiser when the advertiser receives allocations. Through appropriate construction of these computations, incentives may be aligned such that advertisers benefit from truthful reporting of valuations.

### BACKGROUND

Many websites derive funding through selling advertising spaces to advertisers. When displayed on the website to a user, the advertising spaces are typically filled with advertisements that are related to input the user has entered into the website. For instance, when a user enters the keyword “car” into a search engine website, an advertising space on the website could be filled with an advertisement for a particular brand of car and displayed to the user along with results of the search. The advertisement is provided by an advertiser, such as a manufacturer of that brand of car, who pays to have the advertising space allocated to that advertisement for that keyword occurrence. If the user clicks on the displayed advertisement, the user is connected to the advertiser's website, at which the user can decide to purchase the advertised car.

Advertising spaces on websites, such as sponsored search sites, are typically allocated to particular advertisers in an auction process. Each advertiser places a bid on an available advertising space for a desired user input, such as a keyword, and the bids are weighted based on statistical data pertaining to the probability that allocating the advertising space to a particular advertiser will result in a user making a purchase. Then when a user enters the keyword into the website, the advertising space is allocated to the advertiser with the highest weighted bid. The auction process is typically highly automated and repeated for every user interaction with the website, such that the website takes advertiser bids and re-allocates the advertising space each time it receives appropriate input from a user.

Typically, an advertiser who wins an advertising space auction pays an owner of the advertising space through one of two different payment arrangements. In a cost-per-click arrangement, the advertiser only makes a payment if the advertiser wins the auction (i.e., the allocation of the advertising space) and the user clicks on the advertisement. In a cost-per-action arrangement, the advertiser only makes a payment if the advertiser wins the auction, the user clicks on the advertisement, and the user performs a certain action on the advertiser's website, such as purchasing the advertised product. In either of these payment arrangements, the payment amount is determined by the bids placed at auction of the advertising space. To incentivize advertisers to place bids that reflect the truthful value of the advertising space to the advertisers, the payment amount charged to the winning advertiser is typically not the actual amount bid by that advertiser, but rather the next highest amount bid by another advertiser.

In deciding what amount to bid for an advertising space at auction, an advertiser is expected to set a bid based on the value of an allocation of the advertising space to the advertiser. In general, this value depends on the probability that the user will click on the advertisement once the advertising space is allocated to it, the probability that the user will perform the desired action (e.g., purchasing the advertised product) once the user clicks on the advertisement, and the value of that action to the advertiser (e.g., the advertiser's profit margin on the purchase).

In a cost-per-click payment arrangement, the advertiser makes a payment whenever the user clicks on an advertisement allocated to that advertiser. In determining how much to bid for the allocation, the advertiser should thus consider the profit margin for the desired action and the probability of that action given the click. In determining whether to allocate the advertising space to the advertiser, the allocation system may weight the advertiser's bid by the probability of the click given the allocation, which is estimated by the allocation system.

In a cost-per-action payment arrangement, the advertiser only makes a payment when the user performs the desired action. In determining how much to bid for the allocation, the advertiser can thus simply consider the profit margin for the action. In determining whether to allocate the advertising space to the advertiser, the allocation system may weight the advertiser's bid by the probability of the action given the click and the probability of the click given the allocation, which are estimated by the allocation system.

### SUMMARY

The inventors have recognized and appreciated that truthful communication between bidders and a seller may be incentivized, and mutually beneficial pricing schemes may be implemented, through dynamic mechanisms for allocating a resource through multiple allocation cycles. Through such a mechanism, bidders may pay an entrance fee to enter into a long-term contract in which the resource is successively allocated to a winning bidder in each cycle, and payments of a specified form are charged to winning bidders, without re-negotiating bids between allocations. Some embodiments provide a dynamic allocation mechanism that is incentive compatible, achieving a pricing structure that aligns incentives such that bidders benefit from reporting truthful valuations of the resource being allocated. The pricing structure may be computed by a processor of the resource platform based on valuation data that can be easily provided by the bidders as well as statistical data that can be readily generated by the resource platform.

Some embodiments according to the present disclosure provide a dynamic allocation mechanism. Components of a system, including computing devices of an advertising platform and multiple advertisers, may be configured to implement communication rules, allocation rules and payment rules. Communication rules may specify the information collected by the allocation system (e.g., an advertising platform) from the bidders (e.g., advertisers) at particular intervals of the long-term contract for allocation of the resource (e.g., advertising space). In some embodiments, communication rules may specify that each advertiser transmits to the advertising platform an initial report of the advertiser's valuation of the advertising space, prior to commencement of the contract term. In some embodiments, communication rules may also specify that each advertiser may report, at successive cycles, updated valuations and/or observed statistical data pertaining to the rate at which successful user actions result from user selections of allocated advertisements.

Allocation rules may specify how the advertising platform allocates the advertising space at each cycle in which the advertising space becomes available during the long-term contract, given the communication specified by the communication rule. In some embodiments, a processor of the advertising platform may compute an index for each advertiser based on the advertiser's initial valuation of the advertising space. In some embodiments, the advertising platform may also base its computation of the indices on the statistical data received from the advertisers and/or statistical data observed by the advertising platform, such as the rate at which users select particular allocated advertisements. Each time the advertising space becomes available, the advertising platform may allocate the advertising space to the advertiser having the highest index, such that reporting a higher initial valuation increases an advertiser's likelihood of winning an allocation.

Payment rules may specify the circumstances under which the advertising platform requests payments from the advertisers, and the amounts of such payments, as part of the long-term contract. In some embodiments, payment rules may specify that a processor of the advertising platform computes an entrance fee based on each advertiser's initial value report, and charges each advertiser the respective computed entrance fee prior to commencement of the contract term. The advertising platform may compute the entrance fee for each advertiser such that reporting a higher initial valuation increases an advertiser's entrance fee. All advertisers participating in the contract may pay the entrance fee, independent of any allocations. Payment rules may also specify that for each allocation, the advertising platform computes a payment amount to be charged to the advertiser to which the advertising space is allocated. The computed payment amount may be based on the advertiser's initial valuation, such that reporting a higher initial valuation reduces the advertiser's payment amount upon allocation. In some embodiments, the advertising platform may also base its computation of the allocation payment amount on updated value reports and/or statistical data received from the advertiser, and/or statistical data observed by the advertising platform.

In some embodiments, each advertiser's initial value report may be used by a processor of the advertising platform to compute one or more weights for the advertiser. The weights may be derived as a transform of an estimated value of the allocation to the advertiser to an estimated revenue to the seller when the advertising space is allocated to that advertiser. In some embodiments, the weights may be fixed to the advertiser's initial value report, irrespective of updated value reports provided at successive allocation cycles. The weights thus derived may be applied to a Gittins index policy to compute the index used by the allocation rule. The weights may also be applied by the advertising platform in externality computations to compute the payment amounts used by the payment rule.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustrating an exemplary webpage including an advertising space that may be allocated in accordance with some embodiments of the present invention;

FIG. 2 is a block diagram illustrating an exemplary system for allocating advertising spaces in accordance with some embodiments of the present invention;

FIG. 3 is a block diagram illustrating operation of an exemplary system for allocating advertising spaces in accordance with some embodiments of the present invention;

FIG. 4 is a flow chart illustrating an exemplary method for allocating advertising spaces in accordance with some embodiments of the present invention;

FIGS. 5A and 5B, when connected at the points labeled “A”, are a flow chart illustrating a detailed exemplary method for allocating advertising spaces in accordance with some embodiments of the present invention; and

FIG. 6 is a block diagram illustrating an exemplary computing system for use in practicing some embodiments of the present invention.

### DETAILED DESCRIPTION

The inventors have recognized and appreciated that conventional methods for auctioning advertising spaces suffer from various inefficiencies, and often fail to promote full and truthful communication of data between advertisers and the advertising platform. In determining which advertiser will be allocated an advertising space that becomes available, the advertising platform typically considers each advertiser's bid as well as statistical data pertaining to the probability that the allocation will result in success for the advertiser, as indicated by a user clicking on the advertisement and/or subsequently completing a desired action on the advertiser's website. Some of this statistical data is public, and can be directly observed by the advertising platform; however, some of the data is private, and known or observable only by the advertiser. The inventors have recognized and appreciated that conventional auction methods and pricing structures often make it difficult for advertisers to accurately estimate the private statistical data pertinent to determining how much to bid for an advertising space. In addition, conventional arrangements often do not fully incentivize advertisers to be diligent and truthful in reporting to the advertising platform their private statistical data and valuation of the advertising space.

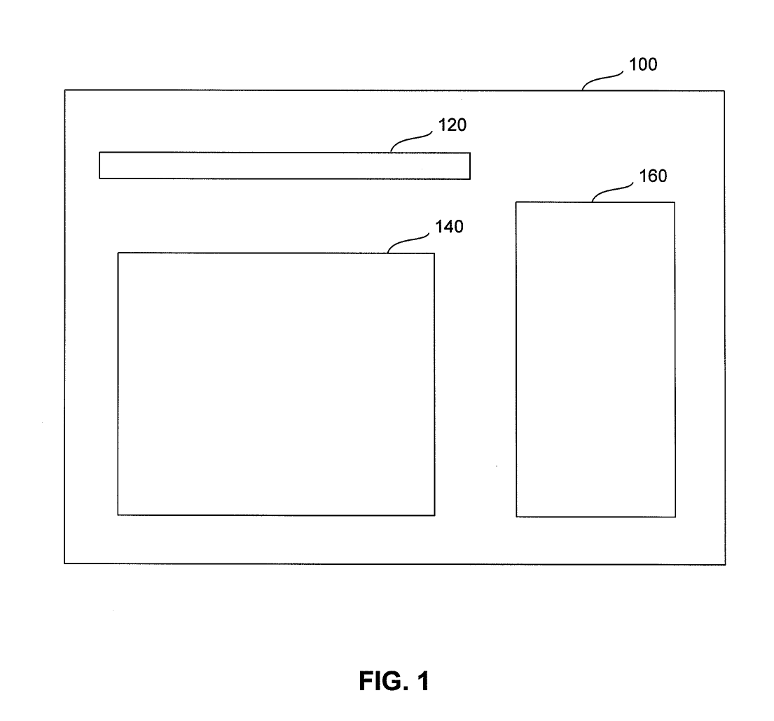

FIG. 1 illustrates an exemplary webpage 100 in which an advertising space 160 may be available for allocation to an advertisement provided by an advertiser, in accordance with some embodiments of the present invention. Webpage 100 may be implemented using known techniques and maintained by a web server, which may be part of an advertising platform or may be implemented by a separate system that interfaces with the advertising platform in any suitable fashion to present webpage 100 with both content and an advertisement. Webpage 100 may be viewed by a user through a web browser application of the user's computing system, using known techniques. Webpage 100 may include one or more fields 120 through which the user may enter input such as text, as well as one or more panels 140 in which content may be displayed to the user. It should be appreciated that webpage 100 may include any number of fields, panels and/or other known webpage components in addition to advertising space 160, and may also include multiple advertising spaces, as aspects of the present invention are not limited in this respect.

In some embodiments, content may be served up by the web server for display to the user in content panel 140, in response to user input entered through field 120. For example, webpage 100 may be a portal to an Internet search engine, and input field 120 may be a text entry field in which a user may input one or more keywords and/or keyword strings for search. In response to the user input, a search engine of the web server may acquire and display appropriate content including search results in content panel 140. In another example, webpage 100 may be a page of another type of website, such as an e-mail application website, and input field 120 may be a field in which a user may input text such as e-mail messages. In other examples, user input may entered in non-textual forms, such as by mouse clicks on selectable text or graphics displayed in content panel 140 or in other areas of webpage 100. It should be appreciated that webpage 100 may be any type or form of webpage that includes one or more advertising spaces 160, and webpage 100 may be configured to allow its web server to receive user input in any appropriate form, as aspects of the present invention are not limited in this respect.

In some embodiments, the web server/advertising platform maintaining webpage 100 may fill advertising space 160 with particular advertisements tailored to interests of the user that it has identified. Such tailoring may increase the likelihood that the user will be interested enough to select the advertisement, for example by clicking on it with a mouse. For example, when the user enters text into input field 120 that contains a particular keyword and/or keyword string, a processor of the advertising platform may automatically identify and select an advertisement for advertising space 160 that has been provided by an advertiser who entered into a contract for that advertising space and keyword/keyword string. In some embodiments, the advertising platform's processor may also be programmed to map user input to a closest keyword for which an advertising contract is in force, even if the user input does not explicitly contain that keyword. Other forms of user input, for example selections of selectable icons, graphics and/or displayed text, may also be mappable to advertising contracts, using any suitable means. It should be appreciated that an advertising platform may identify an appropriate set of advertisements (corresponding to an appropriate pool of advertiser bidders) in response to receiving any suitable form of user input in any suitable way, as aspects of the present invention are not limited in this respect.

Each time user input received by an advertising platform is mapped to a particular keyword or other association for which advertisers have contracted for advertisement placement, one or more associated advertising spaces 160 become available for allocation. When an advertising platform receives appropriate user input and allocates the advertising space 160 to an advertiser, displaying that advertiser's advertisement to the user in advertising space 160 in response to the user input, the time frame of that allocation process is referred to herein as an allocation cycle. Large numbers of allocation cycles may take place for an advertising space in very short time frames, especially when multiple users worldwide may concurrently view the same webpage 100 and enter user input associated with the same advertising space 160.

Under conventional advertising space auction arrangements, an allocation of advertising space 160 to an advertiser in an allocation cycle does not necessarily result in revenue to the advertising platform. For example, in a cost-per-click arrangement, the advertising platform receives revenue only when an allocation to an advertiser results in the user being interested enough to select the advertisement displayed in advertising space 160 during that allocation cycle. The expected value to the advertising platform of allocating advertising space 160 to the advertiser thus depends on that advertiser's bid weighted by the likelihood that a user will select the advertisement given the allocation. The advertising platform can estimate this likelihood by collecting directly observable statistical data related to the rate at which users select each advertiser's advertisements when advertising space 160 is allocated to them. A user may select an advertisement, for example, by clicking on advertising space 160 with a mouse when advertising space 160 is allocated to that advertisement. Statistical data related to rates of such user selections may thus be referred to as click-through rates. Statistical data such as click-through rates may be observed through results of past allocations, and thus they evolve with time and subsequent allocations, such that the advertising platform continually learns about the advertisers' success rates for an individual advertisement or in the aggregate for multiple advertisements over time.

Similarly, in a cost-per-action arrangement, the advertising platform receives revenue only when an allocation to an advertiser results in the user selecting the advertisement and subsequently performing a valuable action at the advertiser's site. The expected value to the advertising platform of allocating advertising space 160 to the advertiser thus depends on that advertiser's bid weighted by the likelihood that a user will select the advertisement given the allocation (which can be estimated using the directly observable click-through rate), as well as the likelihood that the user, having selected the advertisement, will perform the valuable action. The latter likelihood can be estimated by collecting statistical data related to the rate at which users perform valuable actions after having clicked on an advertisement and having transferred to an advertiser's website. Such data may be referred to as an action rate per click. Since the actions occur at advertisers' websites, action rate data may be private to individual advertisers, and not directly observable by the advertising platform. To accurately assess the expected value to the advertising platform of allocating advertising space 160 to different advertisers, the advertising platform may rely on individual advertisers to accurately report action rate data as they are learned privately by the advertisers over time. In addition, the advertising platform may rely on advertisers to accurately report when a current action has occurred, so that the advertising platform may charge the advertiser the cost-per-action payment for the allocation.

The inventors have recognized and appreciated that conventional allocation and pricing methods for advertising spaces, such as cost-per-click and cost-per-action, with new auctions for each allocation, may not fully incentivize advertisers to truthfully and accurately report the private data needed by the advertising platform to determine a mutually beneficial allocation and pricing structure. For example, in a cost-per-action arrangement, it may be difficult to encourage an advertiser to accurately report that an action has occurred and payment is expected. However, inaccurate reporting may actually be harmful to the advertiser in other respects, as underreporting an action rate may make it less likely that an advertising space will be allocated to the advertiser, as the advertising platform weights the advertiser's bids by the available statistical data in selecting an advertiser when allocating an advertising space.

The inventors have also recognized and appreciated that conventional methods for auctioning advertising spaces may place a burden on advertisers to strategize as to how much to bid on an advertising space. For example, in a cost-per-click arrangement, advertisers may find need to hire analysts to strategize as to how to structure bids in the face of private action rate data and the bids of other advertisers. When new auctions are held for every allocation, it may be temporally infeasible for an advertiser to submit different bids for every auction, but advertisers may find need to re-analyze and re-structure bids on the order of every few minutes. Similarly, in a cost-per-action arrangement, advertisers may also find need to strategize and re-strategize bidding and reporting structures, given the above-discussed lack of incentive to simply report truthfully and accurately the advertisers' private data. Such repeated analysis, strategy development and bid structuring may require advertisers to invest heavily in computer equipment and programming to manage large amounts of data gathering, processing, modeling and communication.

The above-mentioned and other disadvantages of conventional advertising space auctions may be overcome by aspects of the present invention, including dynamic allocation and pricing mechanisms involving long-term contracts that align incentives of advertisers and an advertising platform. A long-term contract may be in force for a certain time period, such as a day or a portion of a day, or for a certain number of allocation cycles, for example on the order of hundreds or thousands of allocation cycles. It should be appreciated that a long-term contract may have any suitable duration covering multiple allocation cycles, as aspects of the present invention are not limited in this respect.

In some embodiments, each advertiser may pay an entrance fee to participate in the contract. In some embodiments, advertisers may pay this entrance fee irrespective of whether the advertising space is allocated to that advertiser in any allocation cycles of the contract. In some embodiments, entrance fees may be charged to advertisers as lump sums at the beginning of the contract, while in other embodiments, entrance fees may be divided into increments that may be charged to the advertisers over the duration of the contract.

At each allocation cycle, an allocation payment may be charged only to the advertiser to whom the advertising space is allocated in that cycle. The advertising platform may compute the entrance fee and any allocation payments individually for each advertiser based on an initial valuation of the desired action corresponding to the advertisement, which the advertiser may transmit to the advertising platform prior to commencement of the contract term. Optionally, in some embodiments, an advertiser may also transmit to the advertising platform updated valuations and/or private statistical data such as action rates during the contract term, to affect the likelihood of allocation and the amount of any allocation payments in subsequent allocation cycles.

In reporting an initial valuation to the advertising platform at the beginning of a contract, an advertiser may be free to report any arbitrary value according to any desired criteria. Whatever initial valuation is received, the advertising platform may use this valuation in computing the advertiser's entrance fee, in determining whether to allocate the advertising space to the advertiser in each allocation cycle, and in computing the advertiser's allocation payments. However, in some embodiments, the advertising platform's computations may be structured such that the advertiser's expected revenue from the contract is greatest when the initial valuation is tied to a specific metric, for example, the advertiser's declared profit margin on a purchase of a product advertised in the advertisement. Thus, the communication, allocation and payment rules of the allocation system may be structured to incentivize all advertisers participating in the contract to report initial valuations based on a shared metric tied to their respective beliefs about the value of actions that may result from allocations. An advertiser's computing system may easily be programmed to generate such a valuation from financial records, without need to strategize to produce a bid dependent on complex statistical data and analysis. In addition, providing only an initial valuation at the start of a long-term contract may alleviate any need for the advertiser to re-analyze and re-structure bids for subsequent allocation cycles during the contract term.

In some embodiments, the advertising platform's computations of entrance fees, allocations and allocation payments may be balanced such that advertisers are incentivized to transmit truthful and accurate initial valuations to the advertising platform according to a metric shared by all advertisers participating in the contract. The computations may be performed such that, if an advertiser chose to increase the amount of the advertiser's initial valuation, this would result in an increased entrance fee, an increased likelihood of allocation of the advertising space to the advertiser, and decreased allocation payment amounts in the event of allocations to the advertiser. In some embodiments, specific construction of the computations by a processor of the advertising platform may result in an incentive compatible allocation mechanism. The incentives of all advertisers may be aligned such that each advertiser achieves greater returns from the contract by reporting truthfully. In some embodiments, advertisers may also be incentivized to truthfully report updated valuations and private statistical data in successive allocation cycles, as the advertising platform may determine successive allocations and compute successive allocation payments based on such updated data.

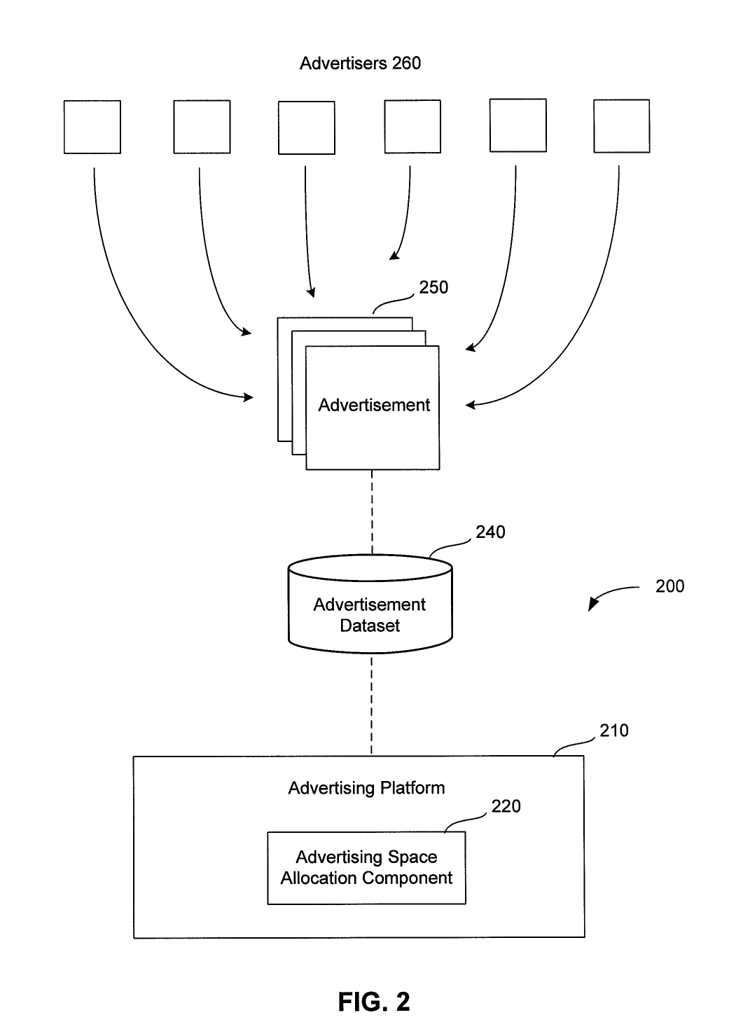

FIG. 2 illustrates an exemplary system 200 for allocating advertising spaces in accordance with some embodiments of the present invention. System 200 may include an advertisement dataset 240 that stores a number of advertisements 250, each advertisement having been provided by one of multiple advertisers 260. Advertisement dataset 240 may be implemented in any suitable form including any of various forms known in the art, for example as one or more computer-readable storage media encoded with data representing advertisements 250. Advertisement dataset 240 may be operatively connected to an advertising platform 210 using any suitable means, including wired and/or wireless connections. Alternatively, advertisement dataset 240 may be accessible to advertising platform 210 through a network such as a local-area network, medium-area network or wide-area network such as the Internet. Similarly, advertisers 260 may supply advertisements 250 in electronic form to advertisement dataset 240 through any suitable form of physical or network connection.

Advertising platform 210 may be implemented as one or more computer systems, including one or more processors programmed to perform aspects of the present invention described herein. Program code instructions executable by the one or more processors may include instructions to implement an advertising space allocation component 220. Computer-executable instructions implementing advertising space allocation component 220 may be encoded in one or more tangible, non-transitory computer-readable storage media operatively connected to advertising platform 210 and its one or more processors. The computer-executable instructions, when executed by the one or more processors of advertising platform 210, may implement functions of advertising space allocation component 220 to allocate available advertising spaces to advertisements 250 provided by advertisers 260. Advertising space allocation component 220 may also include any suitable hardware components of advertising platform 210 configured to implement aspects of the present invention described herein.

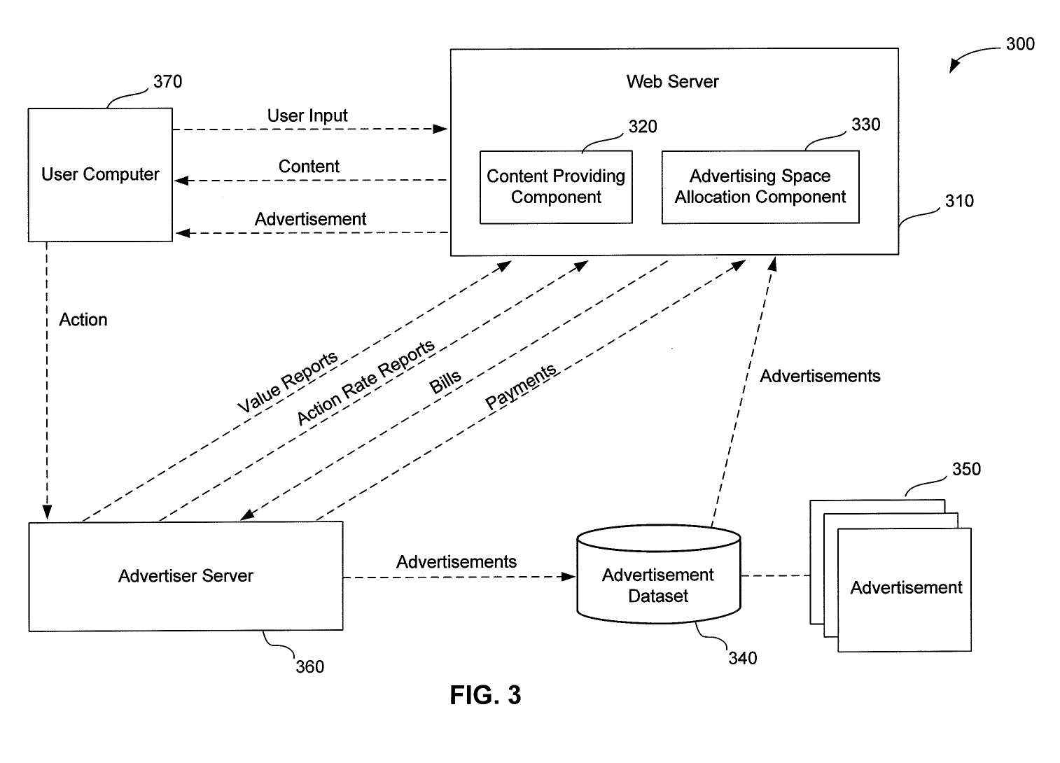

FIG. 3 illustrates operation of an exemplary system 300 for allocating an advertising space to an advertiser, in accordance with some embodiments of the present invention. Although interactions are illustrated with respect to only one advertiser in FIG. 3, it should be appreciated that such interactions may be generalized to any number of advertisers, as illustrated previously in FIG. 2. It should be appreciated that any number of advertisers may participate in a long-term contract for allocation of an advertising space, in accordance with some embodiments of the present invention, as aspects of the present invention are not limited in this respect.

FIG. 3 illustrates a web server 310, representing an exemplary component of an advertising platform. Web server 310 may be implemented as one or more computer systems, including one or more processors configured to perform aspects of the present invention described herein. Web server 310 may include a content providing component 320 and an advertising space allocation component 330. Content providing component 320 and advertising space allocation component 330 may each be implemented as program code embodied on one or more tangible, non-transitory computer-readable storage media, including computer-executable instructions that can be executed by the one or more processors of web server 310.

A user computer 370, which may be implemented in any of various forms as known in the art, may communicate with web server 310 through any suitable network connection(s), examples of which are provided herein. In response to receiving user input from a user of computer 370, web server 310 may, through execution of functions of content providing component 320, transmit appropriate content to user computer 370 for display as part of a webpage. Web server 310 may also, through execution of functions of advertising space allocation component 330, select an advertisement 350 to which to allocate an advertising space of the webpage, and transmit the selected advertisement in the advertising space of the webpage to user computer 370.

Web server 310 may obtain advertisements 350 to be selected by advertising space allocation component 330 from an advertisement dataset 340. Web server 310 may have access to advertisement dataset 340 through any suitable local or network connection(s), examples of which are provided herein. Advertisement dataset 340 may also be accessible through any suitable network connection(s) to advertiser server 360, which may provide one or more advertisements to be stored in advertisement dataset 340. Advertisements 350 may be stored in advertisement dataset 340 through any suitable technique(s) and in any suitable form(s), as aspects of the present invention are not limited in this respect.

Advertiser server 360 may be owned and/or operated by a representative advertiser, who may enter into a contract with the advertising platform associated with web server 310 for multiple allocation cycles of an advertising space. Although only one advertiser server 360 is illustrated in FIG. 3, it should be appreciated that web server 310 may interact with any number of advertiser servers corresponding to different advertisers participating in one or more advertising space allocation contracts with the advertising platform corresponding to web server 310.

Advertiser server 360 may be implemented as one or more computer systems, including one or more processors configured to perform aspects of the present invention described herein. Advertiser server 360 may include one or more tangible, non-transitory computer-readable storage media encoded with computer-executable instructions that, when executed by the one or more processors of advertiser server 360, perform various processes as described herein. Advertiser server 360 may communicate with web server 310 and with user computer 370 through any suitable network connection(s), examples of which are provided herein.

The one or more processors of advertiser server 360 may be programmed to perform various functions in compliance with a long-term contract into which the corresponding advertiser may enter for multiple allocation cycles of an advertising space managed by web server 310. In some embodiments, advertiser server 360 may, through operations performed by its one or more processors, compute an initial value report and transmit the initial value report to web server 310 at the beginning of the long-term contract. The initial value report may be computed to reflect the perceived value to the advertiser of having the advertiser's advertisement allocated to the advertising space, or the perceived value of a desired user action that may result from the advertisement being allocated to the advertising space. In some embodiments, computing systems of all advertisers participating in the contract may be programmed to compute initial value reports according to similar metrics, in compliance with communication rules of the contract. For example, advertiser server 360 may be programmed to compute the initial value report to represent the advertiser's profit margin on a product advertised in the advertiser's advertisement.

In response to receiving the initial value report from advertiser server 360, the one or more processors of web server 310 may compute an entrance fee for the advertiser based on the received initial value report. In some embodiments, web server 310 may compute the entrance fee in such a way that, if advertiser server 360 were to have transmitted a higher initial value report, a higher entrance fee would have been computed. Conversely, if advertiser server 360 were to have transmitted a lower initial value report, a lower entrance fee would have been computed. As an example, details of an exemplary embodiment of such a computation are described below.

Web server 310 and advertiser server 360 may be configured to exchange payment information to transact the advertiser's payment of the computed entrance fee in any suitable way, as aspects of the present invention are not limited in this respect. For instance, in one example, web server 310 may transmit a bill to advertiser server 360 for the entrance fee amount, and advertiser server 360 may transmit payment information allowing web server 310 to transact an electronic transfer of funds in the amount of the entrance fee to a financial account associated with an owner and/or operator of web server 310. In another example, the advertiser may have a pre-established account from which web server 310 may automatically deduct funds to transact payment of the entrance fee. If multiple advertisers are participating in a contract, the one or more processors of web server 310 may compute individual entrance fees for each advertiser based on initial value reports provided by each advertiser. A computed entrance fee may be charged to each participating advertiser, regardless of which advertisers may receive allocations during the contract term.

In some embodiments, entrance fees may be charged to advertisers as lump sums at the beginning of the contract. In other embodiments, each advertiser's entrance fee may be divided into smaller increments that may be separately charged to the advertiser at different times during the term of the contract, as a subscription fee. Increments of the entrance fee may be divided evenly, such that the subscription fee is constant each time it is charged, or different increments may be charged at different times. Increments of the entrance fee may be charged at constant time intervals during the term of the contract, or the time intervals between payments of increments of the entrance fee may vary. It should be appreciated that entrance and/or subscription fees may be divided and spread over all or a portion of the term of the contract in any suitable way, as aspects of the present invention are not limited in this respect. In still other embodiments, some advertisers participating in the contract may pay lump sum entrance fees while other advertisers participating in the contract may pay divided subscription fees. In various embodiments, advertisers may choose payment options and/or payment options may be assigned to certain advertisers in any suitable way according to any suitable criteria, as aspects of the present invention are not limited in this respect.

In some embodiments, advertiser server 360 may also be programmed to transmit action rate reports to web server 310. Action rate reports may represent private statistical data observed and/or estimated by advertiser server 360, pertaining to rates at which users perform valuable actions on the advertiser's website given that the users select the advertiser's advertisement to which the advertising space was allocated. Such action rates may have been learned by advertiser server 360 over time, for example through experience with past allocation cycles or allocation contracts, or may be estimated by advertiser server 360 using information known to the advertiser. Web server 310 may be programmed to use such action rate reports, when available, in computing entrance fees, allocations and allocation payments for the advertiser. In some embodiments, web server 310 may also be programmed to consider statistical data such as click-through rates in its computations. Click-through rates may be directly observable by web server 310, and may be updated over time as the advertising space is allocated in successive allocation cycles, and users are observed to either click on the allocated advertising space or not.

Each time web server 310 receives user input that can be appropriately mapped to the advertising contract entered into by the advertiser of advertiser server 360, the corresponding advertising space becomes available for allocation in an allocation cycle of the contract. In some embodiments, the one or more processors of web server 310 may compute an index for each advertiser in each allocation cycle of the contract, for use in determining to which advertiser to allocate the advertising space for that allocation cycle. Web server 310 may compute these indices based at least in part on the initial value reports received from the advertisers' servers, such that, if an advertiser were to have reported a higher initial value report, a higher index would have been computed. Conversely, if an advertiser were to have reported a lower initial value report, a lower index would have been computed. As an example, details of an exemplary embodiment of such a computation are described below. Web server 310 may be programmed to allocate the available advertising space, in each allocation cycle, to the advertiser with the highest index computed for that allocation cycle. Thus, reporting a higher initial value report may have the effect of increasing the likelihood for the advertiser of receiving allocations during the contract.

If, in an allocation cycle, the advertising space is allocated to an advertisement provided by advertiser server 360, web server 310 may transmit that advertisement in the advertising space to user computer 370. The advertisement in the advertising space may be selectable by the user of computer 370 and, if the user selects the advertisement, the user's network connection may be transferred to advertiser server 360, through which the user may have the opportunity to perform an action of value to the advertiser. In some embodiments, such a valuable action may include purchasing a product advertised in the advertisement selected by the user. In other embodiments, such an action may include signing up for a service, joining a mailing list, providing information, or any of numerous other suitable actions, as aspects of the present invention are not limited in this respect. Each time an advertisement is transmitted to a user in an allocated advertising space, web server 310 may learn and update stored statistical data pertaining to the click-through rate of that advertisement. Each time a user selects an advertisement in an allocated advertising space and visits advertiser server 360, advertiser server 360 may learn and update stored statistical data pertaining to the action rate per click for that advertisement.

When web server 310 allocates the advertising space in each allocation cycle, the one or more processors of web server 310 may compute a payment amount to be charged to the advertiser to whom the advertising space was allocated in that allocation cycle. For example, if, in an allocation cycle, the advertising space is allocated to an advertisement provided by advertiser server 360, web server 310 may compute a payment amount based on the initial value report received from advertiser server 360. The payment amount may be computed in such a way that, if the advertiser were to have reported a higher initial value report, a lower payment amount would have been computed. Conversely, if the advertiser were to have reported a lower initial vale report, a higher payment amount would have been computed. As an example, details of an exemplary embodiment of such a computation are described below. Web server 310 may transmit a bill for the payment amount to advertiser server 360, and advertiser server 360 may transmit the requested payment to web server 310. Bills and payments may be transmitted in any suitable form using any suitable technique, as aspects of the present invention are not limited in this respect.

In some embodiments, advertiser server 360 may transmit updated value reports and updated action rate reports to web server 310 during successive allocation cycles while the long-term contract is effective. When available, these updated reports may be used by the one or more processors of web server 310 in computing the advertiser's index and/or any allocation payment amounts in the respective allocation cycles. For example, increased valuations and action rates reported by advertiser server 360 may have effects of increasing the likelihood of allocation to the advertiser. Web server 310 may also directly observe and/or estimate the advertiser's click-through rate and consider it in computing the advertiser's index and/or any allocation payment amounts. For example, an increased click-through rate may increase the likelihood of allocation to the advertiser.

In some embodiments, a portion of the computation of advertiser indices and/or allocation payment amounts may be fixed to the initial valuations reported by the advertisers at the beginning of the long-term contract. For example, in some embodiments, the one or more processors of web server 310 may be programmed to compute one or more weights for each advertiser, based on the advertiser's initial valuation. The one or more weights, whose computation may be fixed to the initial valuation, irrespective of later updated valuations transmitted by the advertiser, may be applied to weight computations of indices and/or allocation payment amounts in successive allocation cycles. Although the computations of indices and/or allocation payment amounts may also consider updated valuations that are received, the one or more weights applied to the computations may be fixed to the initial valuations reported at the beginning of the contract. In such a way, advertisers may be provided with an incentive to report valuations truthfully at the beginning of the contract as well as during the contract. As an example, details of an exemplary embodiment of such computations are provided below. In some embodiments, an advertiser may change the reported initial valuation at the beginning of a new contract, thus going into the new contract with different weights to be applied to allocation and/or pricing computations during the new contract.

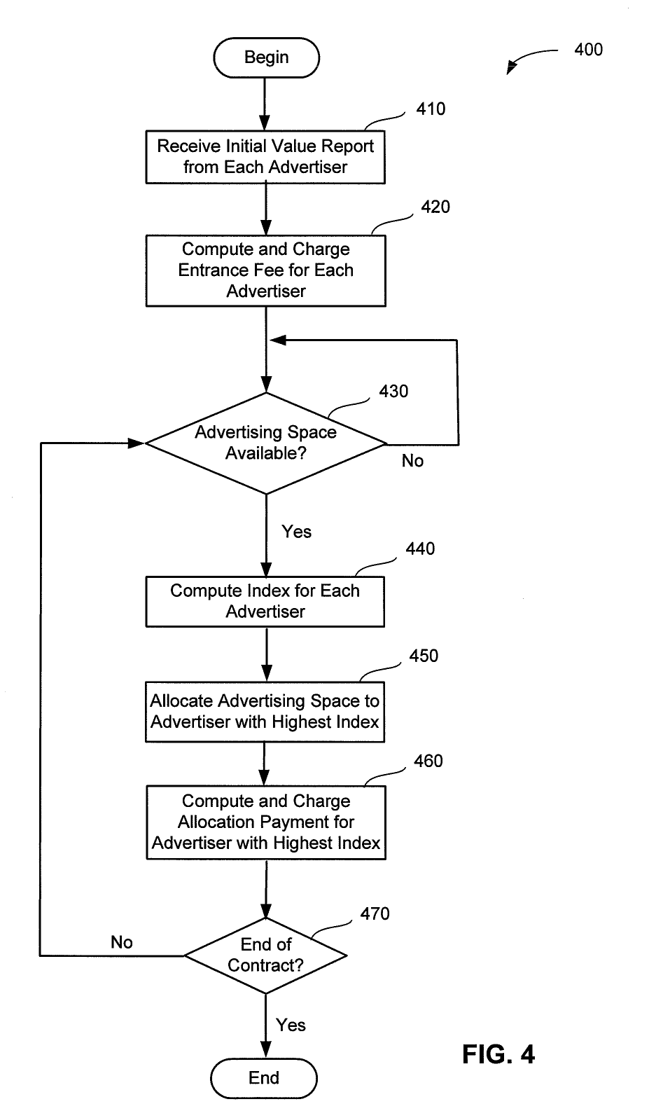

FIG. 4 illustrates an exemplary method 400 for allocating an advertising space through multiple allocation cycles of a long-term contract, in accordance with some embodiments of the present invention. Method 400 may be performed for each advertising space, for each period over which a long-term contract is in effect. For a given contract, method 400 begins at act 410, at which an advertising platform may receive an initial value report from each advertiser desiring to participate in the long-term contract. At act 420, the advertising platform may, through execution of program code by one or more processors of the advertising platform, compute an entrance fee for each advertiser, based on that advertiser's initial value report. The advertising platform may compute the entrance fee for each advertiser according to a function that yields a higher entrance fee for a higher initial value report, all other function variables being equal. Having computed the entrance fee amount, the advertising platform may charge the computed entrance fee as a lump sum and/or subscription fee to each advertiser participating in the contract, independent of any allocation or lack of allocation that the advertiser may receive during the contract period.

At act 430, the advertising platform may determine whether the advertising space corresponding to the contract has become available. The advertising space may become available when the advertising platform receives user input appropriate to the advertising contract currently under consideration. Until the advertising space becomes available, method 400 may remain at act 430. When it is determined that the advertising space has become available, a new allocation cycle begins, and method 400 may proceed to act 440.

At act 440, the one or more processors of the advertising platform may compute an index for each advertiser. The indices may be computed based on the initial value reports received from the advertisers. The advertising platform may compute the index for each advertiser according to a function that yields a higher index for a higher initial value report, all other function variables being equal. At act 450, the advertising platform may allocate the advertising space to the advertiser with the highest index computed in act 440. Having allocated the advertising space to an advertiser, the advertising platform may transmit that advertiser's advertisement in the advertising space in a webpage to the user.

At act 460, the one or more processors of the advertising platform may compute an allocation payment to be charged to the advertiser to whom the advertising space was allocated (e.g., the advertiser with the highest index computed in act 440). The allocation payment amount maybe computed based on the initial value report received from the advertiser. The advertising platform may compute the allocation payment amount according to a function that yields a lower allocation payment amount for a higher initial value report, all other function variables being equal. Having computed the allocation payment amount, the advertising platform may charge the computed allocation payment to the advertiser to whom the advertising space was allocated.

At act 470, a determination may be made as to whether the long-term contract has ended. In some embodiments, a long-term contract may be constructed to expire at the end of a predetermined time period, such as a day. In other embodiments, a long-term contract may be constructed to expire after a predetermined number of allocation cycles. It should be appreciated that contracts of any suitable length may be implemented, as aspects of the present invention are not limited in this regard. If it is determined at act 470 that the current contract has not yet ended, method 400 may loop back to act 430, at which the advertising platform may wait for the next allocation cycle. If it is determined at act 470 that the current contract has expired, method 400 may end. The method may be begun again for a next long-term contract, for which new initial value reports may be received.

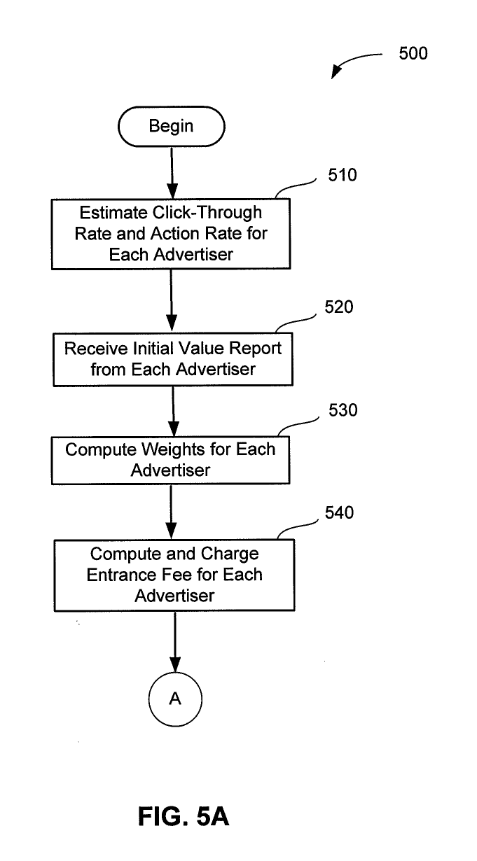

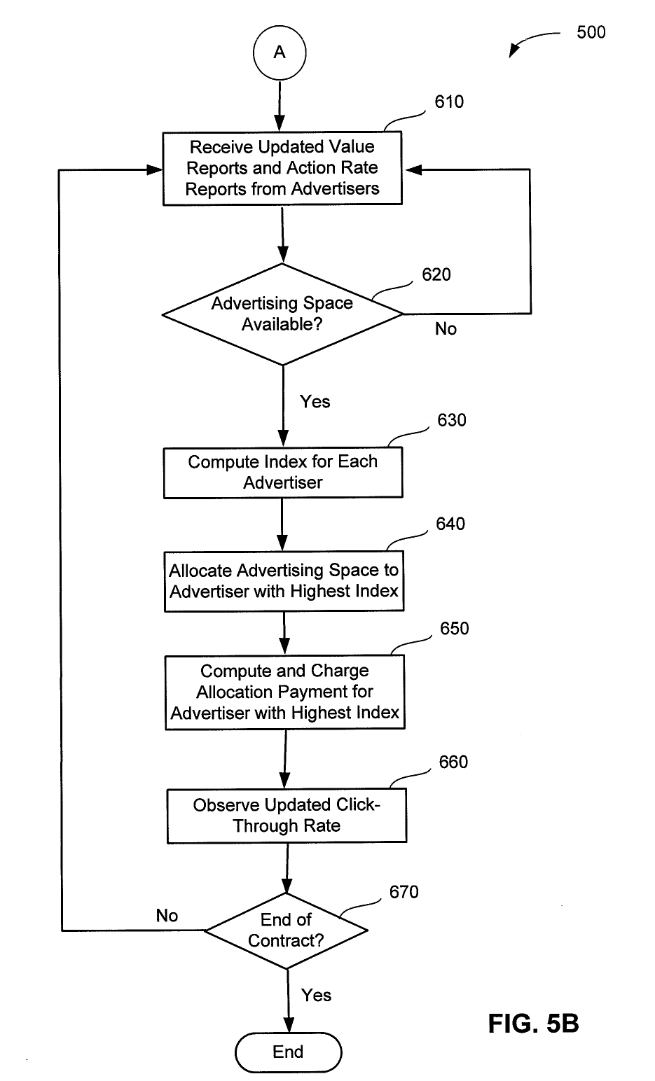

FIGS. 5A and 5B illustrate an exemplary detailed method 500 for allocating an advertising space through multiple allocation cycles of a long-term contract, in accordance with some embodiments of the present invention. Method 500 begins at act 510, at which an advertising platform may, through processing by one or more processors, estimate initial statistical data such as a click-through rate per allocation ρ_{i,0} and an action rate per click e_{i,0} at allocation cycle 0 for each advertiser i participating in the contract. As discussed above, click-through rates ρ_{i,t} may be directly observed and/or estimated by the advertising platform at all allocation cycles t. Action rates e_{i,t} may be observed and/or estimated by the individual advertisers, and reported by the advertisers to the advertising platform. In some embodiments, if any action rates are not reported to the advertising platform, the one or more processors of the advertising platform may estimate the non-reported action rates based on past action rates, action rates of similar advertisers, or in any other suitable way, as aspects of the present invention are not limited in this respect.

At act 520, the advertising platform may receive an initial value report θ_{i,0} from each advertiser. Each advertiser may be free to report whatever amount he chooses for his initial valuation; however, as discussed above, computations of entrance fees, allocations and allocation payment amounts in accordance with embodiments of the present invention may incentivize each advertiser to truthfully report his valuation of the resource being allocated. If truthful, an advertiser's initial value report θ_{i,0} may represent the advertiser's belief about the value of an action resulting from an allocation of the advertising space to the advertiser. In combination with the estimated click-through rates ρ_{i,t} and action rates e_{i,t}, the value v_{i,t} to an advertiser of an allocation in any allocation cycle t may be estimated by:

v_{i,t}(θ_{i,t},e_{i,t},ρ_{i,t})=θ_{i,t}·Pr(purchase|e_{i,t},click)·Pr(click|ρ_{i,t})

At act 530, the one or more processors of the advertising platform may compute weights αᵢ and βᵢ for each advertiser i. As discussed above, in some embodiments, the computation of weights αᵢ and βᵢ may be fixed to the initial value report θ_{i,0} received from the advertiser at the beginning of the contract, regardless of any updated valuations that may be received from the advertiser later during the contract term.

In some embodiments, weights αᵢ and βᵢ may be computed in one of two ways based on a form in which the value v_{i,t} can be mathematically expressed using known techniques. If, using known mathematical techniques, vᵢ can be expressed as an additive combination of two functions Aᵢ(θᵢ,ρᵢ) and Bᵢ(eᵢ,ρᵢ) as follows:

vᵢ(θᵢ,eᵢ,ρᵢ)=Aᵢ(θᵢ,ρᵢ)+Bᵢ(eᵢ,ρᵢ)

then the weights αᵢ and βᵢ may be computed as:

$${α}_{i} ( {θ}_{i} ) = 1$$

$${β}_{i} ( {θ}_{i} , {ρ}_{i} ) = - \frac{1 - F ( {θ}_{i} )}{f ( {θ}_{i} )} \frac{\partial {A}_{i} ( {θ}_{i} , {ρ}_{i} )}{\partial {θ}_{i} }$$

where F(θᵢ) is a distribution according to which θᵢ is independently distributed, and f(θᵢ) is the density of the distribution. On the other hand, if vᵢ can be expressed using known mathematical techniques as a multiplicative combination of two functions Aᵢ(θᵢ) and Bᵢ(eᵢ,ρᵢ), with additive offset −Cᵢ(ρᵢ), as follows:

vᵢ(θᵢ,eᵢ,ρᵢ)=Aᵢ(θᵢ)Bᵢ(eᵢ,ρᵢ)−Cᵢ(ρᵢ)

then the weights αᵢ and βᵢ may be computed as:

$${α}_{i} ( {θ}_{i} ) = 1 - \frac{1 - F ( {θ}_{i} )}{f ( {θ}_{i} )} \frac{{A}_{i}^{′} ( {θ}_{i} )}{{A}_{i} ( {θ}_{i} )}$$

$${β}_{i} ( {θ}_{i} , {ρ}_{i} ) = - \frac{1 - F ( {θ}_{i} )}{f ( {θ}_{i} )} \frac{{A}_{i}^{′} ( {θ}_{i} )}{{A}_{i} ( {θ}_{i} )} {C}_{i} ( {ρ}_{i} )$$

Weights αᵢ and βᵢ thus computed may alternatively be expressed as linear parameters of an affine function that transforms the value v_{i,t} to an advertiser of an allocation to that advertiser to a value ψ_{i,t} to the advertising platform of an allocation to that advertiser, as follows:

ψᵢ(θᵢ,e_{i,t},ρ_{i,t})=αᵢ(θᵢ)vᵢ(θᵢ,e_{i,t},ρ_{i,t})+βᵢ(θᵢ,ρ_{i,t})

where the value ψ_{i,t} is defined as:

$${ψ}_{i} ( {θ}_{i} , {e}_{i , t} , {ρ}_{i , t} ) = {v}_{i} ( {θ}_{i} , {e}_{i , t} , {ρ}_{i , t} ) - \frac{1 - F ( {θ}_{i} )}{f ( {θ}_{i} )} \frac{\partial {v}_{i} ( {θ}_{i} , {e}_{i , t} , {ρ}_{i , t} )}{\partial {θ}_{i} }$$

as described in R. B. Myerson's “Optimal Auction Design” (Mathematics of Operation Research, Vol. 6, No. 1, 1981, pp. 58-73).

At act 540, the one or more processors of the advertising platform may compute an entrance fee to be requested from each advertiser, based on that advertiser's initial value report and the computed weights αᵢ and βᵢ for that advertiser, as well as the initial statistical data collected pertaining to click-through rates and action rates. The advertising platform may compute the entrance fees such that increasing an advertiser's initial value report increases the computed entrance fee for that advertiser. In some embodiments, an entrance fee p_{i,0} for advertiser i at allocation cycle 0 may be computed as follows:

$${p}_{i , 0} = E [ {\sum }_{t = 1}^{∞} {δ}^{t - 1} {q}_{i , t} {ψ}_{i} ( {θ}_{i , 0} , {e}_{i , t} , {ρ}_{i , t} ) ] - E [ {\sum }_{t - 1}^{∞} {δ}^{t - 1} {q}_{i , t} {p}_{i , t} \vert {θ}_{i , 0} ]$$

where δ is a constant, 0<δ<1, selected to discount future returns as known in economic theory; q_{i,t}=1 if the advertising space is allocated to advertiser i in allocation cycle t and 0 otherwise; and p_{i,t} will be defined below.

Once the computed entrance fees have been charged to all advertisers participating in the contract, method 500 may proceed to act 610, at which updated value reports θ_{i,t} and action rates e_{i,t} may be received from individual advertisers for the current allocation cycle t. Any updated value reports θ_{i,t} and action rates e_{i,t} received by the advertising platform may be used in subsequent computations by the one or more processors of the advertising platform. Alternatively, or in the case that any advertiser does not supply updated data reports, the advertising platform may use past data for the current allocation cycle.

At act 620, the advertising platform may determine whether the advertising space corresponding to the contract has become available. The advertising space may become available when the advertising platform receives user input appropriate to the advertising contract currently under consideration. Until the advertising space becomes available, method 500 may loop back to act 610, at which any newly transmitted data from one or more advertisers may be received. When it is determined that the advertising space has become available, a new allocation cycle begins, and method 500 may proceed to act 630.

At act 630, the one or more processors of the advertising platform may compute an index G_{i,t} for each advertiser i for the current allocation cycle t. The indices G_{i,t} may be computed based on the weights αᵢ and βᵢ computed at act 530, as well as any updated value reports and/or statistical data received and/or generated by the one or more processors of the advertising platform. The advertising platform may compute the index G_{i,t} for each advertiser i based on the weights αᵢ and βᵢ such that increasing an advertiser's initial value report increases the computed index for that advertiser. In some embodiments, an index G_{i,t} for advertiser i in allocation cycle t may be computed as follows:

$${G}_{i , t} ( {θ}_{i} , {e}_{i} , {ρ}_{i} ) = {max}_{{τ}_{i}} E [ \frac{{\sum }_{t = 1}^{{τ}_{i}} {δ}^{t - 1} ξ ( {θ}_{i} , {e}_{i , t} , {ρ}_{i , t} )}{{\sum }_{t = 1}^{{τ}_{i}} {δ}^{t - 1}} \vert {θ}_{i} , {e}_{i , 1} = {e}_{i} , {ρ}_{i , 1} = {ρ}_{i} ]$$

where the maximum is taken over all stopping times σᵢ, and:

ξ(θᵢ,e_{i,t},ρ_{i,t})=αᵢ(θ_{i,0})vᵢ(θᵢ,e_{i,t},ρ_{i,t}+βᵢ(θ_{i,0},ρ_{i,t})

The above-described computation for indices G_{i,t} is reminiscent of a Gittins index as described in J. C. Gittins' “Bandit Processes and Dynamic Allocation Indices” (Journal of the Royal Statistical Society. Series B (Methodological), Vol. 41, No. 2, 1979, pp. 148-177). However, the above-described computation constructs a new index that maximizes an alteration of a known social welfare function in economic theory, the alteration weighting the function by the weights αᵢ and βᵢ computed at act 530.

At act 640, the advertising platform may allocate the advertising space to the advertiser with the highest index computed at act 630. Having allocated the advertising space to an advertiser, the advertising platform may transmit that advertiser's advertisement in the advertising space in a webpage to the user. In some embodiments, however, the advertising platform may additionally consider an option not to allocate the advertising space to any advertiser in a particular allocation cycle. For example, the one or more processors of the advertising platform may be programmed to threshold the indices G_{i,t} computed for the advertisers in the current allocation cycle. If no advertiser's index is higher than the predetermined threshold, the advertising platform may leave the advertising space unallocated for that allocation cycle, or may fill the advertising space with other content to be transmitted to the user.

At act 650, the one or more processors of the advertising platform may compute an allocation payment amount p_{i,t} to be requested from the advertiser i (if any) to whom the advertising space was allocated (e.g., the advertiser with the highest index computed in act 630) in the current allocation cycle t. The allocation payment amount P_{i,t} may be computed based on the weights αᵢ and βᵢ computed at act 530, as well as any updated value reports and/or statistical data received and/or generated by the one or more processors of the advertising platform. The advertising platform may compute the allocation payment amount p_{i,t} such that increasing the advertiser's initial value report decreases the computed allocation payment amount. In some embodiments, an allocation payment amount p_{i,t} may be computed as follows:

$${p}_{i , t} = \frac{( 1 - δ ) W ( {θ}_{t} , {e}_{t} , {ρ}_{t} ) - {β}_{i} ( {θ}_{i , 0} , {ρ}_{i , t} )}{{α}_{i} ( {θ}_{i , 0} )}$$

where:

$$W ( θ , e , ρ ) = {max}_{Q} E [ {\sum }_{{t}^{′} = t}^{∞} {\sum }_{j \neq i}^{ } {δ}^{{t}^{′} - 1} {q}_{j , {t}^{′}} ξ ( {θ}_{j} , {e}_{j , {t}^{′}} , {ρ}_{j , {t}^{′}} ) \vert θ , {e}_{t} = e , {ρ}_{i} = ρ ]$$

where Q is a set of allocation rules as described in Bergemann and Välimäki's “Efficient Dynamic Auctions” (Discussion Paper No. 126, Helsinki Center of Economic Research, October 2006).

The above-described computation for allocation payment amounts p_{i,t} is reminiscent of a dynamic Vickrey-Clarke-Groves pricing mechanism, as described by Bergemann and Välimäki. However, the above-described computation constructs a new allocation payment structure that charges an advertiser who receives an allocation a payment representing an estimation of a weighted externality imposed on other advertisers. An externality estimates the amount of harm done to other advertisers who did not receive an allocation and did not receive the economic value of the allocation or the opportunity to learn updated valuation and statistical data through the allocation. The above-described pricing computation inversely weights the theoretical externality using the weights αᵢ and βᵢ computed at act 530. Through such pricing computations, combined with the entrance fee computations of act 540 and the allocation computations of acts 630 and 640, incentives may be aligned such that each advertiser may benefit from greater returns from the contract through truthful reporting.

At act 660, the one or more processors of the advertising platform may generate updated statistical data reflecting an updated click-through rate. The updated click-through rate may be learned by observing whether the user selects the advertisement transmitted in the advertising space in the current allocation cycle. At act 670, a determination may be made as to whether the long-term contract has ended. If it is determined that the current contract has not yet ended, method 500 may loop back to act 610, at which the advertising platform may continue to receive updated value reports and action rate reports from advertisers until the next allocation cycle t. If it is determined at act 670 that the current contract has expired, method 500 may end. The method may be begun again for a next long-term contract, for which new initial value reports may be received.

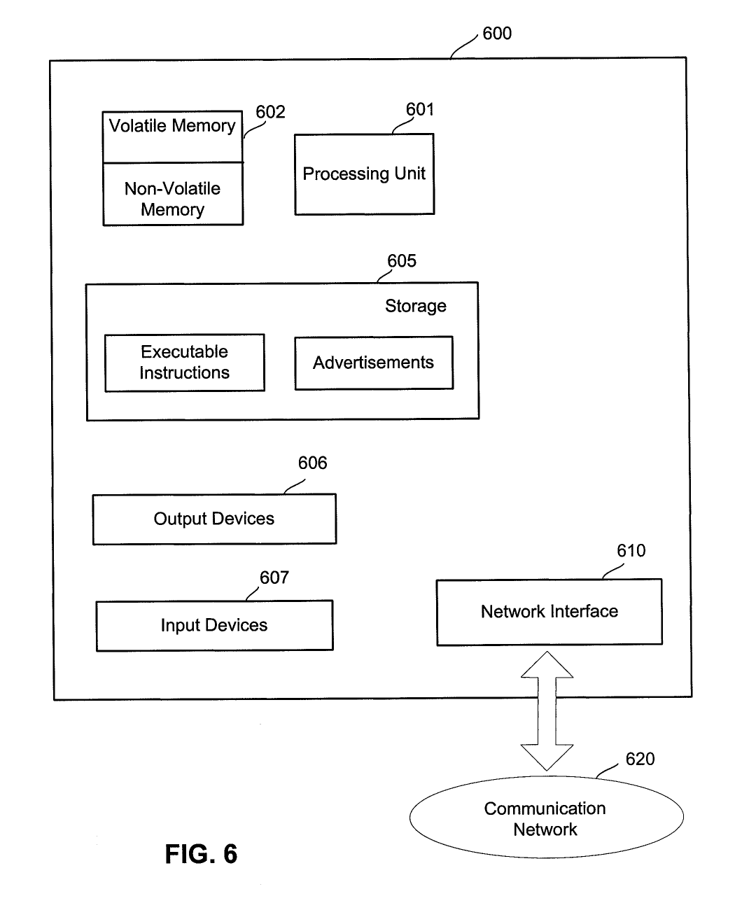

Various inventive aspects described herein may be used with any of one or more computers and/or devices each having one or more processors that may be programmed to take any of the actions described above for allocating advertising spaces. For example, advertising platforms, web servers, advertiser servers and user computing systems may be implemented as one or more computers, as described above. FIG. 6 shows, schematically, an illustrative computer 600 on which various inventive aspects of the present disclosure may be implemented. The computer 600 includes a processor or processing unit 601 and a memory 602 that may include volatile and/or non-volatile memory. The computer 600 may also include storage 605 (e.g., one or more disk drives) in addition to the system memory 602.

The memory 602 and/or storage 605 may store one or more computer-executable instructions to program the processing unit 601 to perform any of the functions described herein. The storage 605 may optionally also store one or more datasets as needed. For example, a computer used to implement web server 310 may in some embodiments store advertisements 350 in storage 605. Alternatively, such datasets may be implemented separately from a computer used to implement web server 310.

References herein to a computer can include any device having a programmed processor, including a rack-mounted computer, a desktop computer, a laptop computer, a tablet computer or any of numerous devices that may not generally be regarded as a computer, which include a programmed processor (e.g., a PDA, an MP3 Player, a mobile telephone, wireless headphones, etc.).

The exemplary computer 600 may have one or more input devices and/or output devices, such as devices 606 and 607 illustrated in FIG. 6. These devices may be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

As shown in FIG. 6, the computer 600 may also comprise one or more network interfaces (e.g., the network interface 610) to enable communication via various networks (e.g., the network 620). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment of this invention, it is to be appreciated that various alterations, modifications, and improvements will readily occur to those skilled in the art. For instance, although examples have been provided of processing and data transmission mechanisms by which a long-term contract may be implemented to allocate a single advertising space, it should be appreciated that such a contract may be implemented to concurrently allocate any number of advertising spaces through multiple allocation cycles. For example, multiple available advertising spaces on a webpage may be ranked in terms of their positioning, size, and/or any other relevant aspect or parameter. During allocation computations in an allocation cycle, the one or more processors of an advertising platform may allocate the highest ranked advertising space to the advertiser with the highest computed index, the next highest ranked advertising space to the advertiser with the next highest computed index, and so on.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for allocating an advertising space, the method comprising:
receiving a plurality of value reports, each value report of the plurality of value reports being received from a respective advertiser of a plurality of advertisers;
computing, using at least one computer, an entrance fee amount to be requested from each advertiser of the plurality of advertisers, wherein the entrance fee amount for each advertiser is based at least in part on the value report received from the respective advertiser, such that increasing the value report increases the computed entrance fee amount;
computing a plurality of indices, each index of the plurality of indices being computed for a respective advertiser of the plurality of advertisers based at least in part on a respective value report of the plurality of value reports received from the respective advertiser; and
allocating the advertising space to an advertiser of the plurality of advertisers based at least in part on the computed indices.

2. The method of claim 1, wherein allocating the advertising space comprises allocating the advertising space to an advertiser of the plurality of advertisers for whom the computed index is higher than the computed indices for others of the plurality of advertisers.

3. The method of claim 1, further comprising computing a payment amount to be requested from the advertiser in response to allocating the advertising space to the advertiser, wherein the payment amount is based at least in part on the value report received from the advertiser, such that increasing the value report decreases the computed payment amount.

4. The method of claim 1, wherein the allocating comprises allocating at a first time, and the method further comprises, at each of a plurality of second times, after the first time, when the advertising space becomes available, allocating the advertising space to an advertiser of the plurality of advertisers selected for the second time.

5. The method of claim 4, wherein:
the method further comprises re-computing the indices based at least in part on statistical data pertaining to success rates of the plurality of advertisers; and
allocating the advertising space at each of the plurality of second times comprises allocating the advertising space to an advertiser of the plurality of advertisers based at least in part on the re-computed indices.

6. The method of claim 5, wherein the statistical data indicate a click-through rate and/or an action rate.

7. The method of claim 5, further comprising receiving at least some of the statistical data from at least some advertisers of the plurality of advertisers.

8. The method of claim 4, wherein:
the method further comprises re-computing the indices based at least in part on updated value reports received from the plurality of advertisers; and
allocating the advertising space at each of the plurality of second times comprises allocating the advertising space to an advertiser of the plurality of advertisers based at least in part on the re-computed indices.

9. A system for allocating a resource to a bidder, the system comprising at least one processor configured to:
receive a declared valuation from the bidder;
compute an initial payment amount to be requested from the bidder, wherein the initial payment amount is independent of any allocation and is based at least in part on the declared valuation, such that increasing the declared valuation increases the computed initial payment amount;
compute an index for the bidder based at least in part on the declared valuation; and
allocate the resource to the bidder based at least in part on the index.

10. The system of claim 9, wherein the at least one processor is configured to compute the index at least in part by:
computing at least one weight for the bidder based at least in part on the declared valuation; and
computing a Gittins index for the bidder using the at least one weight.

11. The system of claim 10, wherein the at least one processor is configured to compute the at least one weight at least in part by computing an affine function of an estimated value for the bidder.

12. The system of claim 9, wherein the at least one processor is configured to allocate the resource to the bidder in response to the index computed for the bidder being higher than at least one other index computed for at least one other bidder.

13. The system of claim 9, wherein the at least one processor is further configured to compute an allocation payment amount to be requested from the bidder in response to allocating the resource to the bidder, wherein the allocation payment amount is based at least in part on the declared valuation, such that increasing the declared valuation decreases the allocation payment amount.

14. The system of claim 9, wherein the at least one processor is further configured to:
re-compute the index based at least in part on statistical data pertaining to success rates of the bidder; and
re-allocate the resource based at least in part on the re-computed index.

15. The system of claim 9, wherein the at least one processor is further configured to:
receive an updated valuation from the bidder;
re-compute the index based at least in part on the updated valuation; and
re-allocate the resource based at least in part on the re-computed index.

16. At least one non-transitory computer-readable storage medium encoded with a plurality of computer-executable instructions that, when executed, perform a method for allocating an advertising space, the method comprising:
a) receiving an initial value report from an advertiser;
b) computing at least one weight for the advertiser based at least in part on the initial value report;
c) receiving an action rate report from the advertiser;
d) computing an index for the advertiser based at least in part on the at least one weight and information received in act c);
e) allocating the advertising space based at least in part on the index; and
f) repeating acts c) through e) for subsequent allocations, using the at least one weight computed in act b).

17. The at least one non-transitory computer-readable storage medium of claim 16, wherein act e) comprises allocating the advertising space to the advertiser in response to the index computed for the advertiser being higher than at least one other index computed for at least one other advertiser.

18. The at least one non-transitory computer-readable storage medium of claim 16, wherein the method further comprises computing an entrance fee amount to be requested from the advertiser, wherein the entrance fee amount is based at least in part on the initial value report.

19. The at least one non-transitory computer-readable storage medium of claim 16, wherein the method further comprises computing a payment amount to be requested from the advertiser in response to allocating the advertising space to the advertiser, wherein the payment amount is based at least in part on the at least one weight and information received in act c).

20. The at least one non-transitory computer-readable storage medium of claim 16, wherein act c) further comprises receiving an updated value report from the advertiser.
